(19) United States
(12) Patent Application Publication
(10) Pub. No.: US 2009/0287491 A1
(43) Pub. Date: Nov. 19, 2009

(54) DATA PROCESSING APPARATUS, SPEECH CONVERSION METHOD, AND SPEECH CONVERSION PROGRAM EMBODIED ON COMPUTER READABLE MEDIUM

(75) Inventor: Hirotomo Ishii, Osaka (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Chiyoda-ku (JP)

(21) Appl. No.: 12/465,960

(22) Filed: May 14, 2009

(30) Foreign Application Priority Data
May 15, 2008 (JP) 2008-128047

(51) Int. Cl. G10L 21/00; H04L 9/32

(52) U.S. Cl. 704/273; 726/2; 704/E21.003

(57) ABSTRACT

In order to limit the range of externally outputable content of externally input speech, an MFP includes: a speech acquiring portion to acquire externally input speech; a speech converting portion to convert the acquired speech into character information; a user extracting portion to extract user identification information for identifying a user from the character information; and an output control portion to output the character information based on the extracted user identification information.

This application is based on Japanese Patent Application No. 2008-128047 filed with Japan Patent Office on May 15, 2008, the entire content of which is hereby incorporated by reference.

### BACKGROUND OF THE INVENTION

1. Field of the Invention

The present invention relates to a data processing apparatus, a speech conversion method, and a speech conversion program, and more particularly to a data processing apparatus provided with a speech recognition function, a speech conversion method executed by the data processing apparatus, and a speech conversion program executed by the data processing apparatus.

2. Description of the Related Art

Conventional making of minutes of meetings involved, for example, recording speech at the meetings on voice recorders for minutes makers to later listen to reproduced sounds of the speech, to make the minutes. Japanese Patent Laid-Open No. 11-242669 discloses a document processing apparatus that creates speaker attribute information from input speech; stores combined information of information about an indicated location in a document, the input speech, and the speaker attribute information; and outputs a sentence in such a manner that the input speech and the speaker attribute information are visually recognizable.

The conventional technique involves storing, as electronic data, a document attached with the combined information of the information about an indicated location in the document, the input speech, and the speaker attribute information. When the speech contains confidential information, and if the electronic data should leak out, the confidential information might leak out. Although introducing limited access to the electronic data can limit people's access to the electronic data, the limited access must be placed on an electronic data basis, resulting in laborious work.

### SUMMARY OF THE INVENTION

The present invention is made to solve the aforementioned problems. An object of the present invention is to provide a data processing apparatus capable of limiting the range of externally outputable content of externally input speech.

Another object of the present invention is to provide a data processing apparatus capable of automatically transmitting character information into which speech is converted.

Another object of the present invention is to provide a speech conversion method capable of limiting the range of externally outputable content of externally input speech.

Another object of the present invention is to provide a speech conversion program capable of limiting the range of externally outputable content of externally input speech.

In order to achieve the aforementioned objects, a data processing apparatus according to an aspect of the present invention includes: a speech acquiring portion to acquire externally input speech; a speech converting portion to convert the acquired speech into character information; a user extracting portion to extract user identification information for identifying a user from the character information; and an output control portion to output the character information based on the extracted user identification information.

According to another aspect of the present invention, a data processing apparatus includes: a speech acquiring portion to acquire externally input speech; a speech converting portion to convert the acquired speech into character information; a transmission destination extracting portion to extract, from the character information, transmission destination information to which data is transmitted; and a transmitting portion to transmit the character information based on the extracted transmission destination information.

According to another aspect of the present invention, a speech conversion method includes: acquiring externally input speech; converting the acquired speech into character information; extracting user identification information for identifying a user from the character information; and outputting the character information based on the extracted user identification information.

According to another aspect of the present invention, a speech conversion program embodied on a computer readable medium causes a computer to execute processing including steps of: acquiring externally input speech; converting the acquired speech into character information; extracting user identification information for identifying a user from the character information; authenticating the user; and outputting the character information based on the extracted user identification information.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic diagram of a minutes making system according to an embodiment of the present invention.

FIG. 2 is a perspective view of an MFP.

FIG. 3 is a block diagram showing an exemplary hardware structure of the MFP.

FIG. 4 is a functional block diagram showing exemplary functions of a television-conference terminal apparatus.

FIG. 5 is a functional block diagram showing exemplary functions of the CPU of the MFP together with data stored in HDD.

FIG. 6 is a diagram showing an exemplary format of a user control record.

FIG. 7 is a diagram showing an exemplary format of a corresponding record.

FIG. 8 is a flowchart showing an exemplary flow of minutes outputting processing.

FIG. 9 is a flowchart showing an exemplary flow of authentication outputting processing.

### DESCRIPTION OF THE PREFERRED EMBODIMENTS

The preferred embodiments of the present invention will be described below in conjunction with the drawings. In the following description, the same or corresponding parts are denoted by the same reference characters. Their names and functions are also the same. Thus, a detailed description thereof will not be repeated.

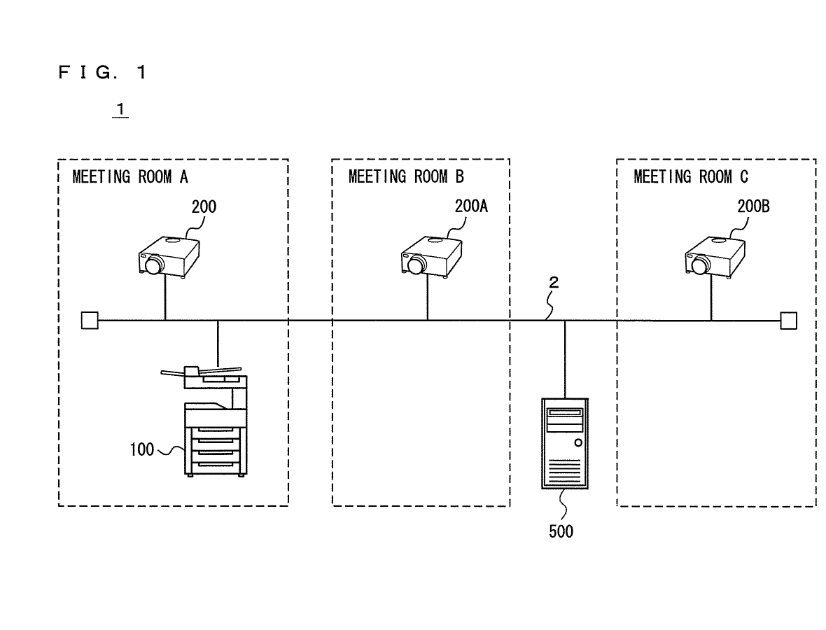

FIG. 1 is a schematic diagram of a minutes making system 1 according to an embodiment of the present invention. Referring to FIG. 1, minutes making system 1 is divided into physically separated spaces, namely, meeting rooms A, B, and C, and a network 2 is established through meeting rooms A, B, and C. Located in meeting room A are an MFP (Multi Function Peripheral) 100 and a television-conference terminal apparatus 200, each of which is connected to network 2. Located in meeting rooms B and C are television-conference terminal apparatuses 200A and 200B, respectively, each of which is connected to network 2. To network 2, a server 500 is also connected. MFP 100 is communicable to television-conference terminal apparatuses 200, 200A, and 200B and server 500 through network 2.

Network 2 is a local area network (LAN), and the form of connection thereof can be either wire or radio. Also, network 2 is not limited to LAN but can be a wide area network (WAN), a public switched telephone network (PSTN), the Internet, or the like.

While in this embodiment description is made of MFP 100 as an example of the data processing apparatus, MFP 100 may be replaced with, for example, a scanner, a printer, a facsimile, or a computer. While in this embodiment description is made of the case of three physically separated spaces, namely, meeting rooms A, B, and C, the number of the spaces is not limited to three; it is possible to use one of meeting rooms A, B, and C or a combination of two or more meeting rooms selected from a plurality of meeting rooms.

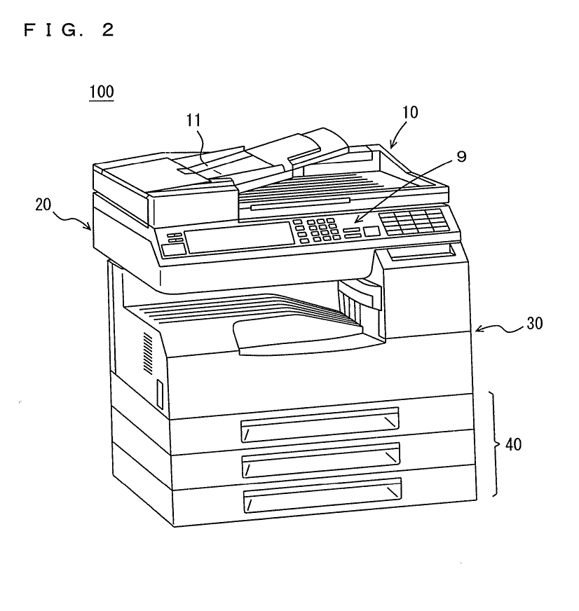

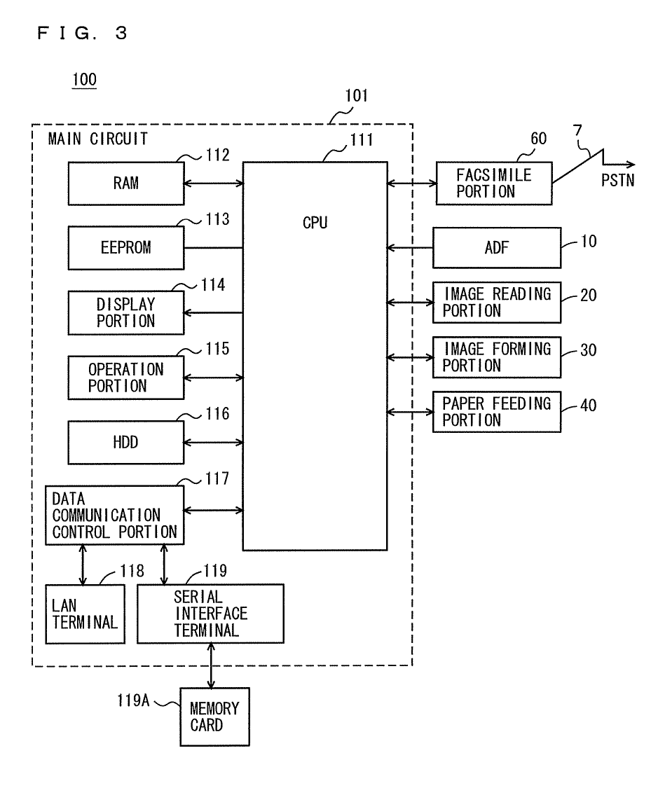

FIG. 2 is a perspective view of MFP 100. FIG. 3 is a block diagram showing an exemplary hardware structure of MFP 100. Referring to FIGS. 2 and 3, MFP 100 includes a main circuit 101, an image reading portion 20 to read a document, an automatic document feeder (ADF) 10 to feed a document to image reading portion 20, an image forming portion 30 to form a static image onto a sheet of paper when the static image read from the document is output from image reading portion 20, a paper feeding portion 40 to supply sheets to image forming portion 30, a facsimile portion 60, and an operation panel 9 serving as a user interface.

ADF 10 handles a plurality of sheets placed on a document tray and conveys them to image reading portion 20 on a one-by-one basis. Image reading portion 20 acquires image data by optically reading image information such as photographs, characters, and pictures from the sheets.

Image forming portion 30, upon input of the image data, forms an image onto a sheet of paper based on the image data. Image forming portion 30 forms a color image using toners of four colors: cyan, magenta, yellow, and black. Image forming portion 30 also forms a monochrome image using a toner of any one of the four colors: cyan, magenta, yellow, and black.

Paper feeding portion 40 stores sheets and supplies them to image forming portion 30 on a one-by-one basis. MFP 100 has operation panel 9 on top thereof.

Main circuit 101 is connected to facsimile portion 60, ADF 10, image reading portion 20, image forming portion 30, and paper feeding portion 40. Main circuit 101 includes a central processing unit (CPU) 111, a RAM (Random Access Memory) 112 used as a working area for CPU 111, an EEROM (Electronically Erasable and Programmable Read Only Memory) 113 that stores a program and the like executed by CPU 111, a display portion 114, an operation portion 115, a hard disk drive (HDD) 116 serving as a mass storage, and a data communication control portion 117.

CPU 111 is connected to display portion 114, operation portion 115, HDD 116, and data communication control portion 117, in order to generally control main circuit 101. CPU 111 is also connected to facsimile portion 60, ADF 10, image reading portion 20, image forming portion 30, and paper feeding portion 40, in order to generally control MFP 100.

Display portion 14 is a display device such as a liquid crystal display (LCD) and an organic ELD (Electro-luminescence Display), and displays, for example, an instruction menu for users and information about image data that is obtained. Operation portion 115 has a plurality of keys and accepts various instructions and characters and numbers input by user's operations and corresponding to the keys. Also operation portion 115 includes a touch panel provided over display portion 114. Display portion 114 and operation portion 115 constitute operation panel 9.

HDD 116 has a plurality of storage areas each allotted to a different user. In this embodiment, each of the storage areas of HDD 116 will be referred to as a BOX, and information for identifying the BOX will be referred to as BOX identification information.

Data communication control portion 117 has: a LAN terminal 118 serving as an interface for communication in accordance with a communication protocol such as TCP (Transmission Control Protocol) and UDP (User Datagram Protocol); and a serial interface terminal 119 for serial communication. Data communication control portion 117 exchanges data with external appliances connected to LAN terminal 118 or serial interface terminal 119 in accordance with an instruction from CPU 111.

When a IAN cable for connection to network 2 is connected to LAN terminal 118, data communication control portion 117 is communicable to television-conference terminal apparatuses 200, 200A, and 200B through LAN terminal 118.

CPU 111 also controls data communication control portion 117 to read from a memory card 119A a program to be executed by CPU 111, and stores the read program in RAM 112 to execute the program. It should be noted that the recording media to store the program to be executed by CPU 111 is not limited to memory card 119A and can also be media such as a flexible disk, a cassette tape, an optical disk (CD-ROM (Compact Disc-Read Only Memory)/MO (Magnetic Optical Disc)/MD (Mini Disc)/DVD (Digital Versatile Disc)), an IC card, an optical card, and a semiconductor memory such as a masked ROM, an EPROM (Erasable Programmable ROM), and an EEPROM (Electronically EPROM). It is further possible that CPU 111 downloads a program from a computer connected to the Internet and stores the program in HDD 116, or that a computer connected to the Internet writes a program in HDD 116, so that the program stored in HDD 116 is loaded in RAM 112 and executed at CPU 111. The program, as used herein, not only includes a program directly executable by CPU 111, but also a source program, a compressed program, and an encoded program.

Facsimile portion 60 is connected to a PSTN 7 to transmit or receive facsimile data to or from PSTN 7. Facsimile portion 60 stores the received facsimile data in HDD 116 or causes image forming portion 30 to print the facsimile data onto a sheet. Facsimile portion 60 also converts output data read from a document by image reading portion 20 or data stored in HDD 116 into facsimile data, and transmits the facsimile data to a facsimile connected to PSTN 7.

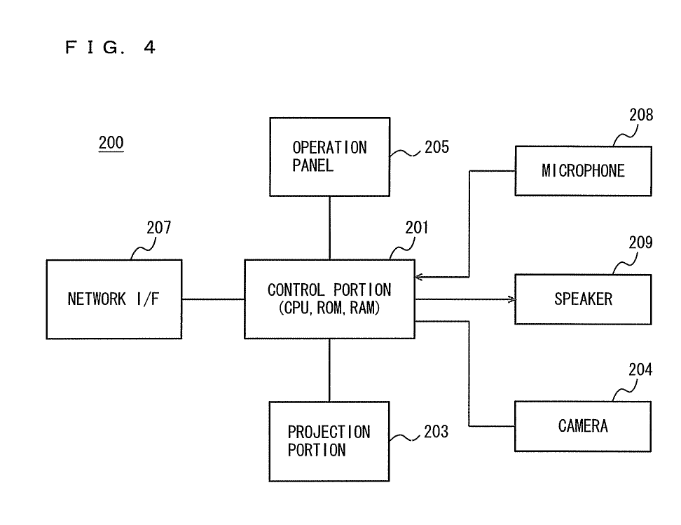

Television-conference terminal apparatuses 200, 200A, and 200B have the same configurations and functions, and description will be made of the case of television-conference terminal apparatus 200. FIG. 4 is a functional block diagram showing exemplary functions of television-conference terminal apparatus 200. Referring to FIG. 4, television-conference terminal apparatus 200 includes a control portion 201 to generally control television-conference terminal apparatus 200, a network I/F 207 to connect television-conference terminal apparatus 200 to network 2, an operation panel 205, a projection portion 203 to project an image, a camera 204 to image the interior of the meeting room, a microphone 208 to collect speech, and a speaker 209 to output speech.

Camera 204 images the interior of meeting room A and outputs image data obtained from the imaging to control portion 201. Microphone 208 collects sound and outputs speech data to control portion 201.

Control portion 201 includes a CPU, a RAM used as a working area, and a ROM to store a program to be executed by the CPU. Control portion 201 transmits image data input from camera 204 and speech data input from microphone 208 to the other television-conference terminal apparatuses 200A and 200B through network I/F 207. This causes the image picked up from the interior of meeting room A and the speech collected from the interior of meeting room A to be output from television-conference terminal apparatuses 200A and 200B. Control portion 201 transmits the speech data to MFP 100. Television-conference terminal apparatuses 200A and 200B also transmit the speech data to MFP 100.

Control portion 201 converts image data received from the other television-conference terminal apparatuses 200A and 200B through network I/F 207 into a projection-purpose format, outputs the projection-purpose data to projection portion 203, and outputs speech data received from the other television-conference terminal apparatuses 200A and 200B to speaker 209. This causes images picked up from the interior of meeting rooms B and C respectively by television-conference terminal apparatuses 200A and 200B and speech collected from the interior of meeting rooms B and C to be output from television-conference terminal apparatus 200.

Projection portion 203 includes a liquid crystal display device, a lens, and a light source. The liquid crystal display device displays data input from control portion 201. The light emitted from the light source passes through the liquid crystal display device and is emitted externally through the lens. When the light emitted from projection portion 203 is projected onto a screen, an enlarged image of the image displayed on the liquid crystal display device is displayed on the screen. A wall or the like with a surface of high reflectivity may be used instead, in which case there is no need for a screen. Operation panel 205 is a user interface and includes a display portion such as a liquid crystal display device and an operation portion including a plurality of keys.

While in this embodiment description is made of the case where television-conference terminal apparatuses 200, 200A, and 200B each have projection portion 203, a display such as an LCD and an organic ELD may be used in place of projection portion 203.

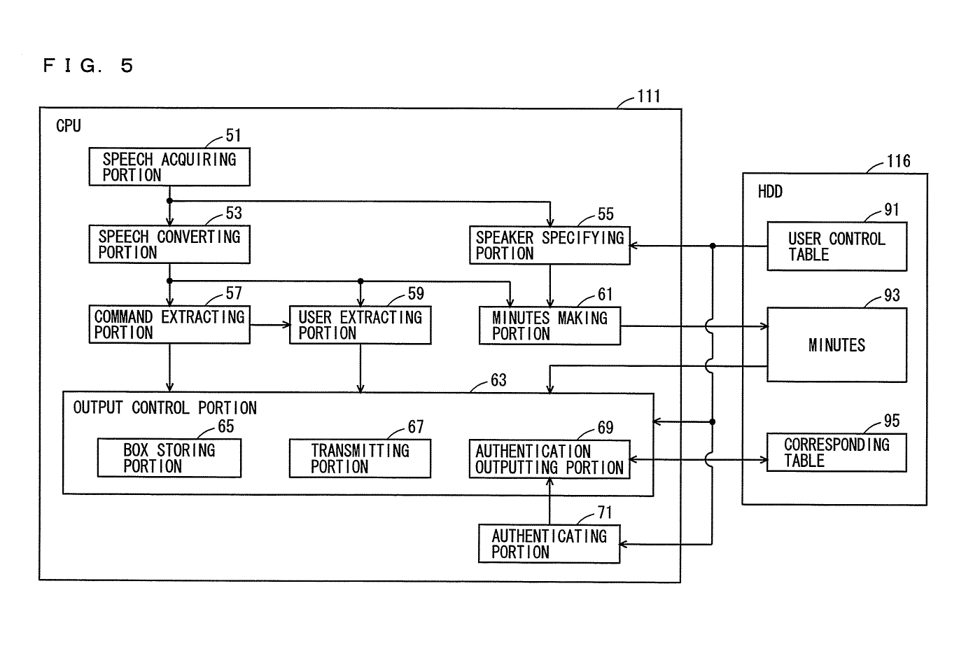

FIG. 5 is a functional block diagram showing exemplary functions of CPU 116 of MFP 100 together with data stored in HDD. HDD 116 of MFP 100 in this embodiment stores a user control table 91 in advance. User control table 91 includes user control records on a user basis. When information associated with a user is input to MFP 100 in advance, a user control record is generated and added to user control table 91.

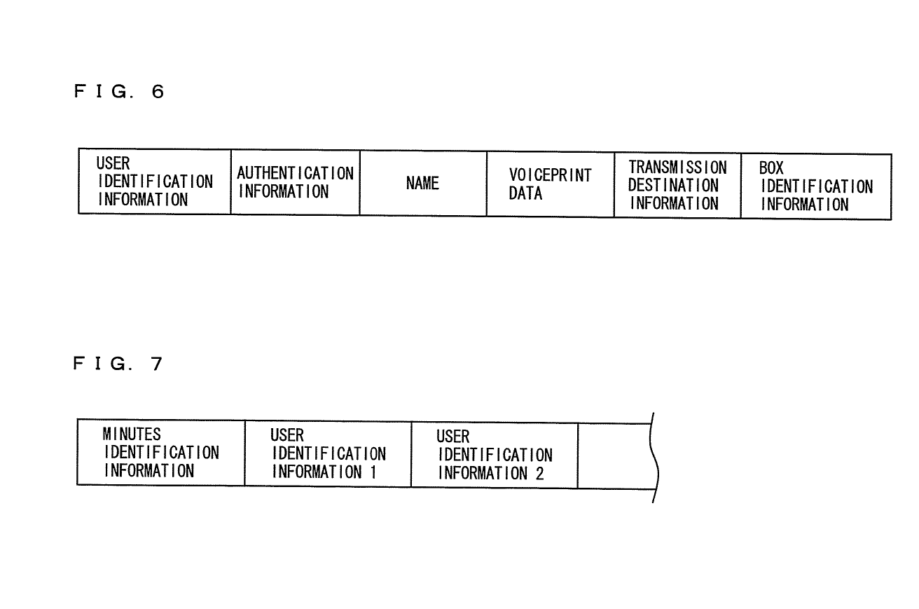

FIG. 6 is a diagram showing an exemplary format of the user control record. Referring to FIG. 6, the user control record includes an item for user identification information, an item for authentication information, an item for name, an item for voiceprint data, an item for transmission destination information, and an item for BOX identification information. The item for user identification information is where user identification information for identifying a user is set. The item for authentication information is where authentication information for authenticating the user is set; in this embodiment, a password is used for the authentication information. The item for name is where the name of the user is set. The item for voiceprint is used for voiceprint recognition and is where a voiceprint of the user is set. The item for transmission destination information is where an address allotted to the user for transmitting data thereto is set; in this embodiment, an electronic mail address is set. The item for BOX identification information is where BOX identification information for identifying a storage area allotted to the user is set from the plurality of storage areas of HDD 116. It should be noted that a name may be used for the user identification information.

Referring back to FIG. 5, CPU 111 includes a speech acquiring portion 51 to acquire externally input speech, a speech converting portion 53 to convert the acquired speech into character information, a speaker specifying portion 55 to specify a user who made the acquired speech, a command extracting portion 57 to extract a command from the character information, a user extracting portion 59 to extract user identification information from the character information, a minutes making portion 61 to make a minutes containing the character information, an output control portion 63 to control output of the character information, and an authenticating portion 71 to authenticate a user who operates MFP 100.

Speech acquiring portion 51 acquires speech data transmitted from television-conference terminal apparatuses 200, 200A, and 200B. Specifically, when data communication control portion 117 receives speech data from television-conference terminal apparatuses 200, 200A, and 200B, speech acquiring portion 51 accepts the speech data from data communication control portion 117. Speech acquiring portion 51 outputs the speech data to speaker specifying portion 55 and speech converting portion 53. While in this embodiment description is made of the case where the speech data to be acquired is transmitted from television-conference terminal apparatuses 200, 200A, and 200B, it is possible to, when the speech at a meeting is stored in a speech storing device such as an IC recorder, acquire speech data from an IC recorder connected to serial interface terminal 119.

Speaker specifying portion 55, upon input of the speech data, specifies a speaker based on the speech data. The speaker is the user who made the speech contained in the speech data. Specifically, speaker specifying portion 55 reads user control table 91 and specifies the speaker of the speech data by using voiceprint data contained in the user control records contained in read user control table 91. Alternatively, the speaker of the speech data may be specified in such a manner that pieces of user identification information of participants of a meeting are acquired from server 500 so that user control records containing the pieces of user identification information of the participants are extracted from the user control records contained in user control table 91 and pieces of voiceprint data contained in the extracted user control records are used to specify the speaker of the speech data. This eliminates the need for using all the user control records contained in user control table 91 and enables the speaker to be specified among the participants, resulting in a relatively short period of time for specifying the speaker. Speaker specifying portion 55 outputs the name of the speaker to minutes making portion 61.

Speech converting portion 53 phonetically recognizes the speech data, converts it into character information, and outputs the character information to command extracting portion 57, user extracting portion 59, and minutes making portion 61. The speech recognition may be carried out in such a manner that speeches of users are stored as pieces of speech recognition data in user control table 91 while being associated with pieces of user identification information so that a piece of speech recognition data of the speaker specified by speaker specifying portion 55 is used for the speech recognition. Thus, the speaker is specified and the speech recognition is carried out using a piece of speech recognition data stored in advance for the speaker, thereby improving the accuracy of the speech recognition.

Command extracting portion 57 extracts a command from the character information input from speech converting portion 53. The command is a predetermined character string, and output control portion 63, described later, is associated with an outputting method by which to output a minutes. The command includes a starting command and an ending command. The starting command and the ending command make up a pair. When extracting the starting command, command extracting portion 57 outputs it to user extracting portion 59, while when extracting the ending command, command extracting portion 57 outputs it to user extracting portion 59 and output control portion 63.

The command in this embodiment includes a transmission command associated with an outputting method by which to output the minutes, a storage command associated with an outputting method by which to store the minutes in a BOX, and an authentication outputting command associated with an outputting method by which to output the minutes on condition that a user who instructs the outputting method is authenticated. For example, the starting command and the ending command of the transmission command are respectively “start transmitting person” and “end transmitting person,” the starting command and the ending command of the storage command are respectively “start storing person” and “end storing person,” and the starting command and the ending command of the authentication outputting command are respectively “start admitting person” and “end admitting person.”

User extracting portion 59 extracts user identification information contained in user control table 91 from the character information input from speech converting portion 53. For the period of time between input of the starting command from command extracting portion 57 and input of the ending command from command extracting portion 57, user extracting portion 59 extracts, as user identification information, character strings that follow the starting command. Speech converting portion 53 outputs character information with spaces inserted corresponding to speech breaks, and thus user extracting portion 59 extracts a plurality of pieces of user identification information by dividing the character string at the spaces. User extracting portion 59 outputs the extracted user identification information to output control portion 63.

Minutes making portion 61 makes a minutes by adding a name input from speaker specifying portion 55 to the character information input from speech converting portion 53, and stores the minutes thus made in HDD 116. Thus, a minutes 93 is stored in HDD 116. Since the user identification information of the user specified by speaker specifying portion 55 is added to the character information input from speech converting portion 53, the user who phonetically made a character string can be specified from the character information.

Output control portion 63 includes a BOX storing portion 65 to store a minutes in a BOX, a transmitting portion 67 to transmit the minutes, and an authentication outputting portion 69 to output the minutes on condition that the operator of MFP 100 is authenticated. Output control portion 63 activates BOX storing portion 65, transmitting portion 67, or authentication outputting portion 69 in accordance with a command input from command extracting portion 57. When the storage command is input, output control portion 63 activates BOX storing portion 65; when the transmission command is input, output control portion 63 activates transmitting portion 67; and when the authentication outputting command is input, output control portion 63 activates authentication outputting portion 69.

When activated, BOX storing portion 65 extracts, from user control table 91 stored in HDD 116, a user control record containing the user identification information input from user extracting portion 59, and acquires BOX identification information set in the BOX identification information item of the extracted user control record. Then BOX storing portion 65 stores minutes 93 stored in HDD 116 in a BOX specified by the acquired BOX identification information.

When activated, transmitting portion 67 extracts, from user control table 91 stored in HDD 116, a user control record containing the user identification information input from user extracting portion 59, and acquires transmission destination information set in the transmission destination information item of the extracted user control record. Then transmitting portion 67 transmits minutes 93 stored in HDD 116 to a transmission destination determined by the acquired transmission destination information by a transmission method determined by the transmission destination information. For example, when an electronic mail address is set in the transmission destination information item, transmitting portion 67 creates an electronic mail attached with the minutes and addressed to the electronic mail address, and transmits the electronic mail to an electronic mail server through data communication control portion 117. When a facsimile number is set in the transmission destination information item, transmitting portion 67 outputs the minutes to facsimile portion 60 to cause it to transmit the character information to a facsimile device with the facsimile number in accordance with a facsimile communication standard. When an IP address is set in the transmission destination information item, transmitting portion 67 causes data communication control portion 117 to transmit the minutes to the IP address in accordance with a communication protocol such as FTP and SMB.

Authentication outputting portion 69 creates a corresponding record that associates the user identification information input from user extracting portion 59 with minutes 93 stored in HDD 116, and stores the corresponding record in a corresponding table 95 stored in HDD 116. Corresponding table 95 contains a single corresponding record for minutes 93 that is stored in HDD 116 by speech converting portion 53. The corresponding record associates minutes 93 stored in HDD 116 with user identification information of a user to whom output of minutes 93 is permitted.

FIG. 7 is a diagram showing an exemplary format of the corresponding record. Referring to FIG. 7, the corresponding record includes an item for minutes identification information and at least one item for user identification information. The item for minutes identification information is where a file name given to minutes 93 is set, and the item for user identification information is where user identification information extracted from character information by user extracting portion 59 is set. The corresponding record associates one minutes 93 containing character information with at least one piece of user identification information.

Referring back to FIG. 5, authenticating portion 71 authenticates a user who operates MFP 100. Authenticating portion 71 displays an authentication screen on display portion 114. When the user inputs user identification information and a password in operation portion 115, authenticating portion 71 accepts them from operation portion 115. Then authenticating portion 71 extracts from user control table 91 a user control record containing the user identification information accepted from operation portion 115, and judges whether a password that the extracted user control record accepted from operation portion 115 and a password contained in the extracted user control record agree. When they agree, authenticating portion 71 authenticates the user, while not authenticating the user when they do not agree. When authenticating the user, authenticating portion 71 outputs the user identification information accepted from operation portion 115 to authentication outputting portion 69.

Upon input of the user identification information from authenticating portion 71, authentication outputting portion 69 extracts, from corresponding table 95 stored in HDD 116, a corresponding record containing the user identification information input from authenticating portion 71. Then authentication outputting portion 69 reads from HDD 116 minutes 93 specified by minutes identification information contained in the extracted corresponding record and outputs minutes 93. An output destination is instructed by the user through operation portion 115. When the user inputs a printing instruction to operation portion 115, authentication outputting portion 69 outputs minutes 93 to image forming portion 30 to cause it to form an image of minutes 93.

When the user inputs a transmission instruction to operation portion 115, authentication outputting portion 69 outputs minutes 93 to a transmission destination specified by the transmission instruction through data communication control portion 117 by a transmission method specified by the transmission instruction. For example, when a transmission instruction designating an electronic mail address is input, authentication outputting portion 69 creates an electronic mail attached with minutes 93 and addressed to the electronic mail address, and transmits the electronic mail to an electronic mail server. When the user inputs a facsimile number to operation portion 115, authentication outputting portion 69 outputs minutes 93 to facsimile portion 60 to cause it to transmit the character information to a facsimile device with the facsimile number in accordance with a facsimile communication standard. When the user inputs an FTP or SMB transmission instruction, authentication outputting portion 69 causes data communication control portion 117 to transmit minutes 93 to an IP address contained in the transmission instruction.

When the user inputs a storing instruction to store minutes 93 in a 5 BOX, authentication outputting portion 69 stores minutes 93 in a BOX specified by BOX identification information that is associated with the user identification information by user control table 91.

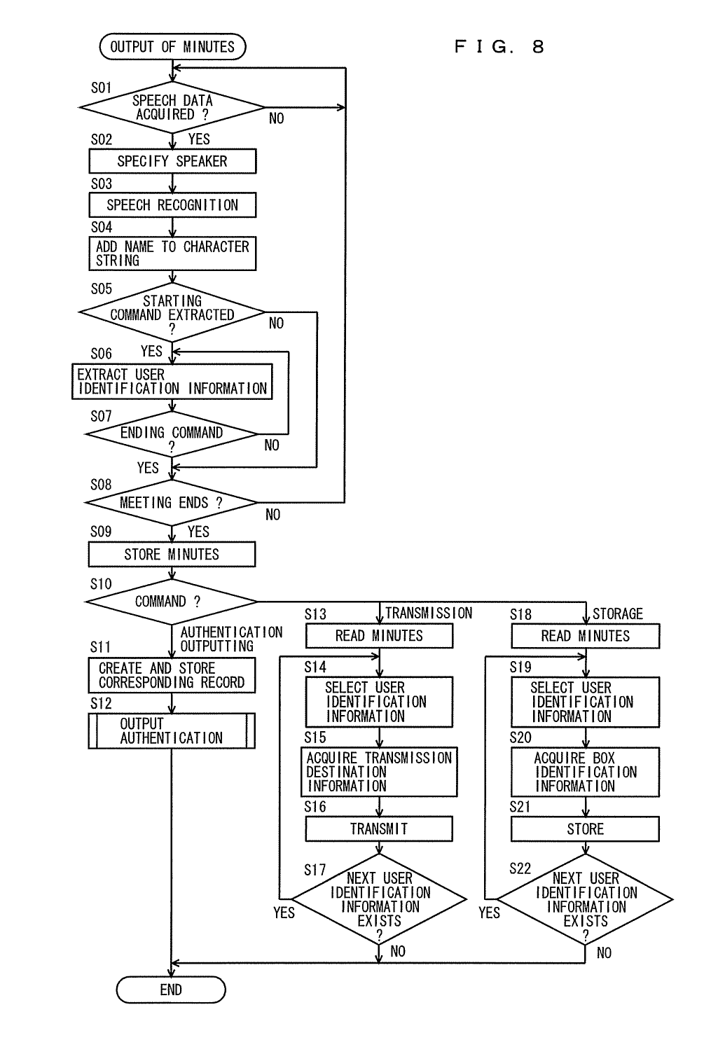

FIG. 8 is a flowchart showing an exemplary flow of minutes outputting processing. The minutes outputting processing is executed by CPU 111 when CPU 111 executes a speech conversion program.

Referring to FIG. 8, CPU 111 judges whether speech data is acquired (step S01). When data communication control portion 117 receives speech data from any of television-conference terminal apparatuses 200, 200A, and 200B, CPU 111 judges that speech is acquired. CPU 111 turns into a stand-by state (“NO” in step S01) until the speech data is acquired. Upon acquirement of the speech data (“YES” in step S01), CPU 111 proceeds the processing to step S02.

In step S02, CPU 111 specifies a speaker based on the speech data. Specifically, CPU 111 specifies the speaker by comparing the speech data with voiceprint data contained in the user control records contained in user control table 91.

In the next step S03, CPU 111 phonetically recognizes the speech data acquired in step S01 using a piece of speech recognition data predetermined for the speaker specified in step S02. Thus, the speaker is specified and the speech recognition is carried out using a piece of speech recognition data stored in advance for the speaker, thereby improving the accuracy of the speech recognition.

In step S04, CPU 111 adds a name of the speaker to a character string contained in character information obtained by the speech recognition of the speech data. Specifically, CPU 111 adds a name associated with the user identification information and the user control record of the speaker specified in step S02 to the character information obtained as a result of the speech recognition of the speech data.

In the next step S05, CPU 111 judges whether a starting command is extracted from the character information obtained by the speech recognition of the speech data. When the starting command is extracted, CPU 111 proceeds the processing to step S06, while otherwise proceeding the processing to step S08. The starting command is a predetermined character string and, in this embodiment, selected from “start transmitting person,” “start storing person,” and “start admitting person.”

In step S06, CPU 111 extracts user identification information from the character information obtained by the speech recognition of the speech data. Specifically, CPU 111 extracts as the user identification information a character string that follows the starting command. When a plurality of character strings divided by spaces follow the starting command, CPU 111 extracts a plurality of character strings as pieces of user identification information. Then CPU 111 judges whether an ending command is extracted from the character information obtained by the speech recognition of the speech data. When the ending command is extracted, CPU 111 proceeds the processing to step S08, while otherwise returning the processing to step S06. In this embodiment, the ending command is selected from “end transmitting person,” “end storing person,” and “end admitting person.” That is, all the space-divided character strings between the starting command and the ending command are extracted as the user identification information.

In the next step S08, CPU 111 judges whether a meeting is ended. When the user of MFP 100 inputs to operation portion 115 an operation indicating the end of the meeting, CPU 111 accepts a meeting ending instruction from operation portion 115. Upon accepting the meeting ending instruction, CPU 111 judges that the meeting is ended and proceeds the processing to step S09, while returning the processing to step S01 when no meeting ending instruction is accepted.

In step S09, CPU 111 stores in HDD 116 a minutes composed of the character information obtained by the speech recognition of the speech data in step S03 and the name added to the character information in step S04. Then CPU 111 diverges the processing according to a command determined by the starting command extracted in step S05 and the ending command extracted in step S06 (step S10). When the command is an authentication outputting command, CPU 111 proceeds the processing to step S11; when the command is a transmission command, CPU 111 proceeds the processing to step S13; and when the command is a storage command, CPU 111 proceeds the processing to step S18.

In step S11, CPU 111 creates a corresponding record, stores it in HDD 116, and proceeds the processing to step S12. The corresponding record associates minutes identification information of the minutes stored in HDD 116 in step S09 with the user identification information extracted in step S06. Then CPU 111 executes authentication outputting processing of outputting the minutes (step S12) and ends the processing. The authentication outputting processing will be described later.

In step S13, CPU 111 reads minutes 93 stored in HDD 116. Then CPU 111 selects, as a processing target, one of the pieces of user identification information extracted in step S06 (step S14). Next, CPU 111 acquires transmission destination information associated with the user identification information selected as the processing target (step S15). Specifically, CPU 111 extracts, from user control table 91 stored in HDD 116, a user control record containing the user identification information selected as the processing target, and acquires transmission destination information set in the transmission destination information item of the extracted user control record.

Next, CPU 111 transmits minutes 93 read in step S13 to a transmission destination determined by the acquired transmission destination information by a transmission method determined by the transmission destination information (step S16). In step S17, CPU 111 judges whether a piece of user identification information next to be targeted for processing exists. When there is an unprocessed piece of user identification information, CPU 111 returns the processing to step S14, while ending the processing when no such user identification information exists.

In step S18, CPU 111 reads minutes 93 stored in HDD 116. Then CPU 111 selects, as a processing target, one of the pieces of user identification information extracted in step S06 (step S19). Next, CPU 111 acquires BOX identification information associated with the user identification information selected as the processing target (step S20). Specifically, CPU 111 extracts, from user control table 91 stored in HDD 116, a user control record containing the BOX identification information selected as the processing target, and acquires BOX identification information set in the BOX identification information item of the extracted user control record.

Next, CPU 111 stores minutes 93 read in step S18 in a BOX specified by the BOX identification information among a plurality of BOXes in HDD 116 (step S21). In step S22, CPU 111 judges whether a piece of user identification information next to be targeted for processing exists. When there is an unprocessed piece of user identification information, CPU 111 returns the processing to step S19, while ending the processing when no such user identification information exists.

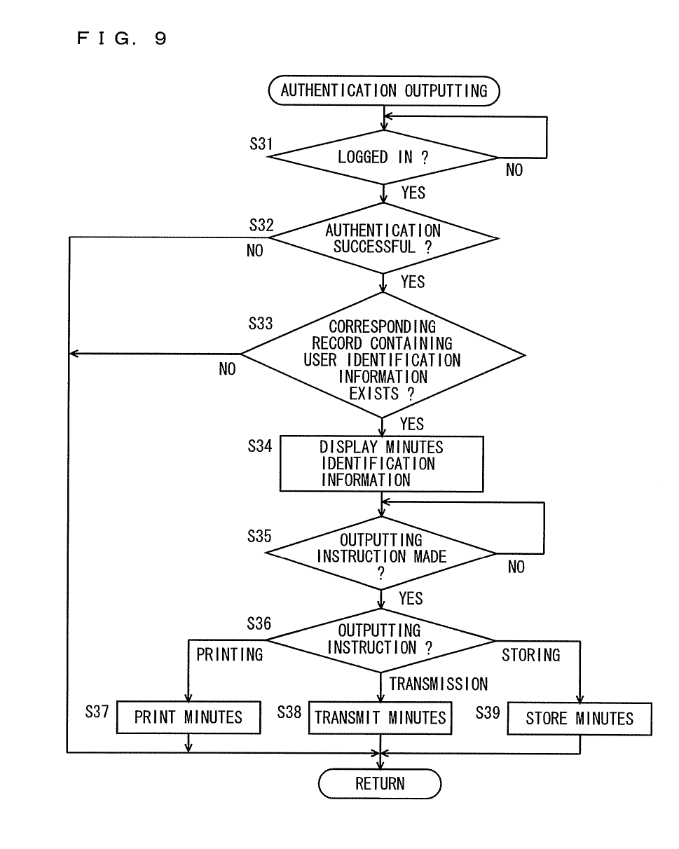

FIG. 9 is a flowchart showing an exemplary flow of authentication outputting processing. The authentication outputting processing is executed in step S12 shown in FIG. 8. Referring to FIG. 9, CPU 111 judges whether a log-in demand is accepted (step S31). Specifically, CPU 111 displays an authentication screen on display portion 114 and judges whether user identification information and a password are input to operation portion 115. Upon detecting that the user identification information and the password are input to operation portion 115, CPU 111 judges that the log-in demand is accepted. CPU 111 turns into a stand-by state (“NO” in step S31) until the log-in demand is accepted. Upon accepting the log-in demand (“YES” in step S31), CPU 111 proceeds the processing to step S32. That is, the processing executed in step S32 and later steps is executed on condition that the log-in demand is accepted.

In step S32, CPU 111 carries out an authentication based on the accepted user identification information and password, and judges whether the authentication is successful. Specifically, CPU 111 extracts, from user control table 91 stored in HDD 116, a user control record containing the accepted user identification information, and judges whether the password accepted from operation portion 115 and a password contained in the extracted user control record agree. When they agree, CPU 111 proceeds the processing to step S33, while when they do not agree, CPU 111 denies the authentication and returns the processing to the minutes outputting processing.

In step S33, CPU 111 judges whether a corresponding record containing the user identification information accepted in step S31 exists. Specifically, CPU 111 searches corresponding table 95 stored in HDD 116 to extract a corresponding record containing the user identification information accepted from operation portion 115. When the corresponding record containing the user identification information accepted from operation portion 115 is extracted, CPU 111 proceeds the processing to step S34, while when no corresponding record is extracted, CPU 111 returns the processing to the minutes outputting processing.

In step S34, CPU 111 displays on display portion 114 minutes identification information set in the minutes identification information item of the extracted corresponding record. Then CPU 111 turns into a stand-by state (“NO” in step S35) until an outputting instruction input by the user is accepted. When operation portion 115 accepts the outputting instruction (“YES” in step S35), CPU 111 proceeds the processing to step S36. In step S36, CPU 111 diverges the processing according to the outputting instruction. When the outputting instruction indicates printing, CPU 111 proceeds the processing to step S37; when the outputting instruction indicates transmission, CPU 111 proceeds the processing to step S38; and when the outputting instruction indicates storage, CPU 111 proceeds the processing to step S39. It should be noted that when extracting a plurality of corresponding records in step S33, CPU 111 displays a plurality of pieces of minutes identification information set for the plurality of corresponding records, and accepts an outputting instruction for each of the plurality of pieces of minutes identification information.

In step S37, CPU 111 reads from HDD 116 minutes 93 specified by minutes identification information set in the corresponding record extracted in step S33, and prints minutes 93. Specifically, CPU 111 outputs minutes 93 to image forming portion 30 to cause it to form an image of minutes 93 onto a sheet.

In step S38, CPU 111 reads from HDD 116 minutes 93 specified by minutes identification information set in the corresponding record extracted in step S33, and transmits minutes 93. Specifically, CPU 111 extracts, from user control table 91 stored in HDD 116, a user control record containing the user identification information accepted in step S31, and transmits minutes 93 in accordance with transmission destination information set in the transmission destination information item of the extracted user control record.

In step S39, CPU 111 reads from HDD 116 minutes 93 specified by minutes identification information set in the corresponding record extracted in step S33, and stores minutes 93 in HDD 116. Specifically, CPU 111 extracts, from user control table 91 stored in HDD 116, a user control record containing the user identification information accepted in step S31. Then CPU 111 stores minutes 93 in a BOX specified by BOX identification information set in the BOX identification information item of the extracted user control record.

### MODIFIED EXAMPLE

While above-described MFP 100 extracts a command and user identification information from character information into which speech is converted, it is possible to extract a command and transmission destination information from the character information. In this case, in the functional block diagram shown in FIG. 5, a transmission destination extracting portion to extract transmission destination information is formed in CPU 111 in place of user extracting portion 59. For example, assume that the starting command is “start transmission destination” and the ending command is “end transmission destination,” and then the transmission destination extracting portion extracts a character string between these commands as the transmission destination information.

Upon extracting the transmission destination information from the character information, the transmission destination extracting portion transmits the transmission destination information to transmitting portion 67. Transmitting portion 67 transmits minutes 93 stored in HDD 116 to a transmission destination determined by the transmission destination information by a transmission method determined by the transmission destination information. For example, when an electronic mail address is used for the transmission destination information, transmitting portion 67 creates an electronic mail attached with the minutes and addressed to the electronic mail address, and transmits the electronic mail. The transmission destination information may be a mailing list that contains a plurality of electronic mail addresses to transmit an electronic mail simultaneously to the plurality of electronic mail addresses. In this case, transmitting portion 67 creates an electronic mail attached with the minutes and addressed to the electronic mail list, and transmits the electronic mail. When a simultaneous-transmission facsimile number is set for the transmission destination information, transmitting portion 67 outputs minutes 93 to facsimile portion 60 to cause it to transmit the character information to a facsimile device with the facsimile number in accordance with a facsimile communication standard. When an IP address is set in the transmission destination information item, transmitting portion 67 causes data communication control portion 117 to transmit minutes 93 to the IP address in accordance with a communication protocol such as FTP and SMB.

As has been described hereinbefore, MFP 100 according to this embodiment converts speech input from any of television-conference terminal apparatuses 200, 200A, and 200B into character information, extracts user identification information from the character information, and outputs the character information based on the user identification information. Thus, the character information is transmitted based on the user identification information, thereby restricting the outputting.

In addition, the character information is transmitted on condition that the user specified by the extracted user identification information is authenticated when operating MFP 100. Thus, if speech resulting from utterance of the user identification information of the authenticated user is not contained in the speech input from the terminal apparatus, an image of character information into which the speech is converted is not formed. This limits persons who are able to instruct outputting of character information into which externally input speech is converted.

The character information into which speech is converted is transmitted based on transmission destination information associated with user identification information extracted from the character information, thereby making it possible to automatically transmit the character information into which speech is converted.

In addition, the character information into which speech is converted is stored in a BOX specified by BOX identification information associated with user identification information extracted from the character information, thereby making it possible to automatically store the character information into which speech is converted.

Further, minutes 93 containing the character information into which speech is converted is output by an outputting method that is predetermined for a command extracted from the character information. When the command is a transmission command, minutes 93 is transmitted; when the command is a storage command, minutes 93 is stored; and when the command is an authentication outputting command, an image of minutes 93 is formed on condition that the user operating MFP 100 is authenticated. Thus, the outputting method of the character information can be contained in the speech, thereby facilitating the setting work at the time of the outputting.

Further, minutes 93 containing the character information into which speech is converted is transmitted based on transmission destination information extracted from the character information, thereby making it possible to automatically transmit the character information into which speech is converted.

While in the above embodiments description has been made of MFP 100 as a data processing apparatus included in minutes making system 1, it will be readily appreciated that the present invention can also be taken as a speech conversion method for executing the processing shown in FIGS. 8 and 9, or as a speech conversion program for causing a computer to execute the speech conversion method.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A data processing apparatus comprising:
a speech acquiring portion to acquire externally input speech;
a speech converting portion to convert said acquired speech into character information;
a user extracting portion to extract user identification information for identifying a user from said character information; and
an output control portion to output said character information based on said extracted user identification information.

2. The data processing apparatus according to claim 1, further comprising an authenticating portion to authenticate said user,
wherein said output control portion includes a conditional outputting portion to output said character information on condition that said user of said extracted user identification information is authenticated by said authenticating portion.

3. The data processing apparatus according to claim 1, wherein said output control portion includes a transmitting portion to transmit said character information to said user of said extracted user identification information.

4. The data processing apparatus according to claim 1, further comprising a storing portion to store data, said storing portion having a plurality of storage areas each associated with a different piece of user identification information,
wherein said output control portion includes a storage control portion to store said character information in a storage area among said plurality of storage areas, said storage area being associated with said extracted user identification information.

5. The data processing apparatus according to claim 1, further comprising a command extracting portion to extract a command from said character information,
wherein said output control portion outputs said character information in response to said extracted command by a predetermined outputting method.

6. A data processing apparatus comprising:
a speech acquiring portion to acquire externally input speech;
a speech converting portion to convert said acquired speech into character information;
a transmission destination extracting portion to extract, from said character information, transmission destination information to which data is transmitted; and
a transmitting portion to transmit said character information based on said extracted transmission destination information.

7. A speech conversion method comprising:
acquiring externally input speech;
converting said acquired speech into character information;
extracting user identification information for identifying a user from said character information; and
outputting said character information based on said extracted user identification information.

8. The speech conversion method according to claim 7, further comprising authenticating said user,
wherein said outputting step includes outputting said character information on condition that said user of said extracted user identification information is authenticated in said authenticating step.

9. The speech conversion method according to claim 7, wherein said outputting step includes transmitting said character information to said user of said extracted user identification information.

10. The speech conversion method according to claim 7, wherein said outputting step includes storing said character information in a storage area among a plurality of storage areas of a storing portion to store data, said storage area being associated in advance with said extracted user identification information.

11. The speech conversion method according to claim 7, further comprising extracting a command from said character information,
wherein said outputting step includes outputting said character information in response to said extracted command by a predetermined outputting method.

12. A speech conversion program embodied on a computer readable medium, said speech conversion program causing a computer to execute processing including steps of:
acquiring externally input speech;
converting said acquired speech into character information;
extracting user identification information for identifying a user from said character information;
authenticating said user; and
outputting said character information based on said extracted user identification information.

13. The speech conversion program according to claim 12, wherein said outputting step includes outputting said character information on condition that said user of said extracted user identification information is authenticated in said authenticating step.

14. The speech conversion program according to claim 12, wherein said outputting step includes transmitting said character information to said user of said extracted user identification information.

15. The speech conversion program according to claim 12, wherein said outputting step includes storing said character information in a storage area among a plurality of storage areas of a storing portion to store data, said storage area being associated in advance with said extracted user identification information.

16. The speech conversion program according to claim 12, further causing said computer to execute a step of extracting a command from said character information,
wherein said outputting step includes outputting said character information in response to said extracted command by a predetermined outputting method.
